(19) United States
(12) Patent Application Publication
(10) Pub. No.: US 2025/0307883 A1
(43) Pub. Date: Oct. 2, 2025

(54) SYSTEM AND METHOD FOR GENERATING STORY PATHS TO INFLUENCE A USER

(71) Applicant: TOYOTA RESEARCH INSTITUTE, INC., Los Altos, CA (US)

(72) Inventor: Francine R. CHEN, Menlo Park, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/619,032

(22) Filed: Mar. 27, 2024

(51) Int. Cl. G06Q 30/0282

(52) U.S. Cl. CPC G06Q 30/0282

(57) ABSTRACT

A method for generating a story path includes receiving, from a source user, a source story. The method additionally includes matching the source story to a topic in a set of topics. The method also includes identifying a set of stories associated with the topic, each story of the set of stories being provided by one or more other users. The method further includes presenting, to the source user based on identifying the set of stories, a subset of stories of the set of stories in a sequence from most similar, in an embedding space, to the source story to least similar, in the embedding space, to the source story. A final story in the sequence is a target story.

### BACKGROUND

### Field

Aspects of the present disclosure generally relate to story paths, and more specifically to systems and methods for generating story paths to influence a user.

### Background

Classification models may be used to predict categorical outcomes by learning patterns and relationships within labeled datasets. These models analyze input features and assign them to classes or categories. Classification models operate by discerning decision boundaries in the data space, effectively mapping input features to the most probable class label. The purpose of classification models is to generalize from the provided training data to accurately classify new, unseen instances.

Feature embedding refers to the process of transforming high-dimensional data into a lower-dimensional space while preserving essential information. In machine learning, feature embedding converts categorical or numerical features into a more compact and meaningful representation, facilitating better model understanding and performance. By mapping each original feature to a continuous vector space, embeddings capture relationships, similarities, and contextual information between different features or items. Feature embedding is commonly used in natural language processing (NLP), where words or phrases are converted into fixed-size vectors, enabling models to understand semantic relationships and contexts, thus enhancing the performance of tasks like language translation, sentiment analysis, and document classification. Feature embedding techniques, such as Word2Vec, GloVe, and Embeddings from Language Models (ELMo), are widely employed to create meaningful representations of data.

### SUMMARY

In one aspect of the present disclosure, a method for generating a story path includes receiving, from a source user, a source story. The method additionally includes matching the source story to a topic in a set of topics. The method also includes identifying a set of stories associated with the topic, each story of the set of stories being provided by one or more other users. The method further includes presenting, to the source user based on identifying the set of stories, a subset of stories of the set of stories in a sequence from most similar, in an embedding space, to the source story to least similar, in the embedding space, to the source story. A final story in the sequence being a target story. The final story is one story of the subset of stories.

Another aspect of the present disclosure is directed to an apparatus including means for receiving, from a source user, a source story. The apparatus also includes means for matching the source story to a topic in a set of topics. The apparatus also includes means for identifying a set of stories associated with the topic, each story of the set of stories being provided by one or more other users. The apparatus further includes means for presenting, to the source user based on identifying the set of stories, a subset of stories of the set of stories in a sequence from most similar, in an embedding space, to the source story to least similar, in the embedding space, to the source story. A final story in the sequence being a target story. The final story is one story of the subset of stories.

In another aspect of the present disclosure, a non-transitory computer-readable medium with non-transitory program code recorded thereon is disclosed. The program code is executed by a processor and includes program code to receive, from a source user, a source story. The program code additionally includes program code to match the source story to a topic in a set of topics. The program code also includes program code to identify a set of stories associated with the topic, each story of the set of stories being provided by one or more other users. The program code also includes program code to present, to the source user based on identifying the set of stories, a subset of stories of the set of stories in a sequence from most similar, in an embedding space, to the source story to least similar, in the embedding space, to the source story. A final story in the sequence being a target story. The final story is one story of the subset of stories.

Another aspect of the present disclosure includes an apparatus including a processor, and a memory coupled with the processor and storing instructions operable, when executed by the processor, to cause the apparatus to receive, from a source user, a source story. Execution of the instructions additionally cause the apparatus to match the source story to a topic in a set of topics. Execution of the instructions also cause the apparatus to identify a set of stories associated with the topic, each story of the set of stories being provided by one or more other users. Execution of the instructions further cause the apparatus to present, to the source user based on identifying the set of stories, a subset of stories of the set of stories in a sequence from most similar, in an embedding space, to the source story to least similar, in the embedding space, to the source story. A final story in the sequence being a target story. The final story is one story of the subset of stories.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system generating content via a story module, in accordance with aspects of the present disclosure.

FIG. 2 is a diagram illustrating an example of a hardware implementation for a system, in accordance with aspects of the present disclosure.

FIG. 3 is a flow diagram illustrating a story path pre-processing pipeline, in accordance with aspects of the present disclosure.

FIG. 4 is a flow diagram illustrating a story path processing pipeline, in accordance with aspects of the present disclosure.

FIG. 5 is a flow diagram illustrating a combined story path processing and pre-processing pipeline, in accordance with aspects of the present disclosure.

FIG. 6 is a block diagram illustrating an example story path, in accordance with aspects of the present disclosure.

FIGS. 7A and 7B are diagrams illustrating an example embedding space and methods to create a story path, in accordance with aspects of the present disclosure.

FIG. 8 is a flow diagram illustrating a method for generating a story path, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

Generative artificial intelligence (AI) models may be trained to discern patterns and establish meaningful connections within datasets of pre-existing content (hereinafter referred to as “training data”). Based on this training, generative models may discern intricate patterns and establish meaningful connections within the input data. When provided with a prompt, a generative model may create content in the form of text, images, and/or music in accordance with the training and/or previous input data.

Recommender systems, often used to create social media feeds, maintain user interaction by predicting a user's interests and presenting posts based on the user's interests. The user's interests may be inferred based on the user's activities, including characteristics regarding what the user clicks on, such as type of media, media content, what posts the user likes, and the posts the user shares. If a user tends to view stories that are sensationalistic, these viewing habits can result in the recommender system showing the user extreme content. For example, people who initially do not believe in an outlandish conspiracy theory may end up believing in the theory after reading extreme stories. On the other hand, if a user clicks on traditional, reputable news sources, it is unlikely that the recommender system will show stories that lead the user to believe in an outlandish theory. Thus, using recommender systems, the set of stories that a user sees is not pre-planned and the system has no goal. Therefore, recommender systems are not feasible tools to incrementally influence a user's emotion, such as empathy, and/or thoughts in one way or another.

Aspects of the present disclosure are directed to a method for generating story paths to influence a user's emotions and/or thoughts. Various aspects of the present disclosure will describe examples of increasing the user's empathy. However, aspects of the present disclosure are not limited to increasing empathy and may be used for increasing or decreasing other emotional states and/or thoughts. In some examples, a story module may identify one or more “target stories,” which are examples of stories by people with a different perspective from an initial (“source”) user. A respective sequence of stories (e.g., a set of stories) is computed from the source user's story to each of the one or more target stories based on difference between a source story from the source user and the one or more target stories. The sequence of stories from the source user's story to a target story may be referred to as a story path. The story module may encourage the source user to view stories by others with different thoughts, views, and/or opinions from the source user by presenting one or more sequences of target stories. In some examples, the story module may initially present the source user stories, in the story path, that are similar to the source user's current viewpoint, incrementally leading the source user to more dissimilar stories.

In some examples, by presenting a sequence of stories (e.g., story path), the story module may move the source user away from one position (e.g., thought), such as an extreme position, to another position, such as a less extreme positions. Additional stories may be added to the story path based on source user behavior. For example, the source user may be prompted to provide feedback about one or more stories in the story path, such as, how empathetic the source user is to a target story. If the source user is not empathetic, the story path could be adjusted to show additional stories on the story path that display viewpoints that are more similar to those of the source user. The story path may be determined based on the source user's answers to one or more questions, a user profile, and/or stories that the source user has viewed or selected. Stories provided by other users, which may be more or less extreme or different in some way, e.g. by providing different solutions to a problem, may be identified as target stories. As discussed, the story module may create a story path for each target story, each target story acting as an endpoint for the respective story path. The story path may expose the source user to different viewpoints and to increase empathy toward the viewpoints. Various aspects of the present disclosure identify target stories and present a story path to the target story to cause a source user to be more empathetic to the target story, which may be very different from what the source user would initially accept.

Particular aspects of the subject matter described in this disclosure can be implemented to realize one or more of the following potential advantages. In some examples, the described techniques, such as generating story paths based on input from a source user, exposes the source user to viewpoints that the source user would otherwise not see or hear, thereby, influencing the source user's thoughts, emotions, viewpoints, and/or feelings. Other advantages include creating multiple story paths, thus providing alternative options for increasing the source user's thoughts, emotions, viewpoints, and/or feelings to a viewpoint.

As used, the term “story module” may generically refer to a device for generating story paths. A story module may implement a neural network, such as a clustering or classification model, to generate story paths by determining similarity between a source user's story and one or more other stories in a dataset. Leveraging neural networks enables the story module to identify patterns, commonalities, or differences among stories. Additionally, story modules may utilize techniques to generate story paths by accounting for user preferences, themes, and/or plot structures from a dataset.

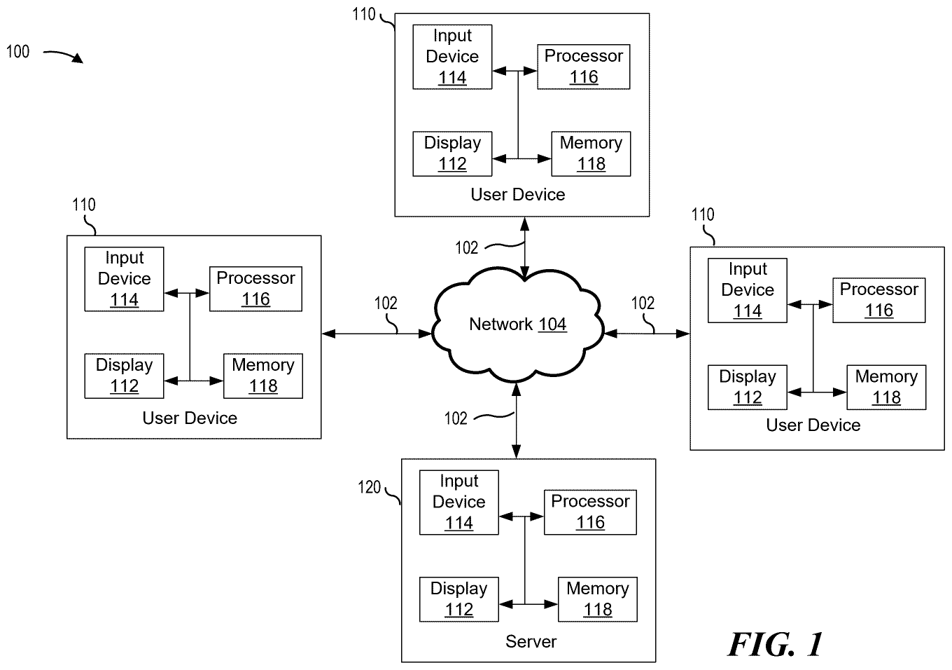

FIG. 1 is a block diagram illustrating an example of a system 100 generating content via a story module, in accordance with aspects of the present disclosure. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a story module and communicate via a wireless or wired medium. In some examples, the server 120 may host a story module. In some such examples, one or more server 120 may work in tandem to host the story module. Specifically, the server 120 may implement functions and/or computer code that runs the story module and/or a site, such as a website, for accessing the story module.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input a prompt to a story module via an interface associated with the story module. The interface may be accessed via a website or a dedicate application, such as a mobile phone application. Additionally, or alternatively, the user device 110 may store the story module, and the user may input a prompt via an interface associated with the stored story module. In some examples, each user device 110 shown in FIG. 1 may be used by a different user. Each user device 110 and server 120 may be stationary or mobile.

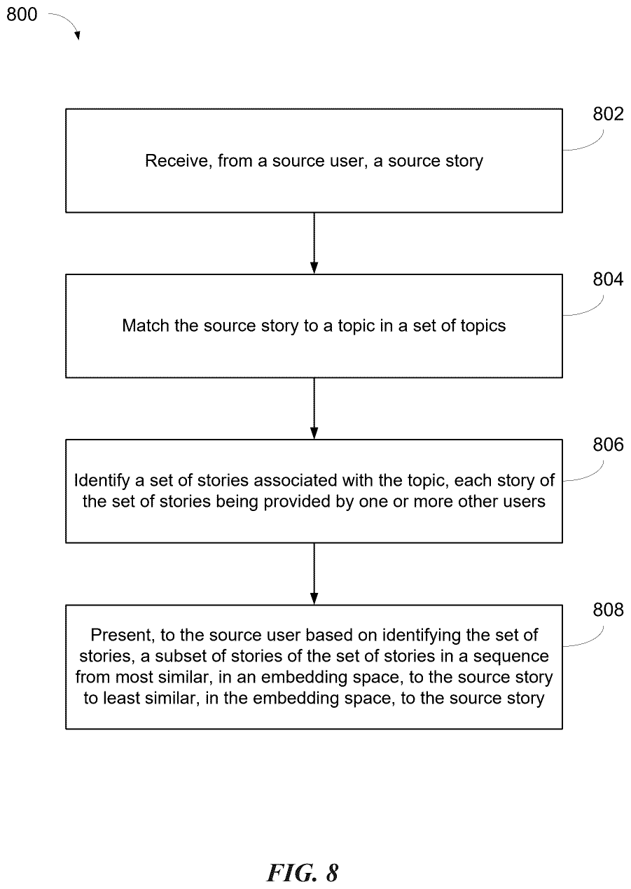

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the story module, provide input to a story module, and/or perform other tasks. Working in conjunction with one or more components of the user device 110, the processor 116 may receive information associated with the story module, and control the display 112 to output information associated with the story module. The display 112 may output (e.g., display) information received at the processor 116. In some examples, the processor 116 of the user device 110 is configured to perform operations and implement one or more elements associated with one or more processes, such as the process 800 described with respect to FIG. 8.

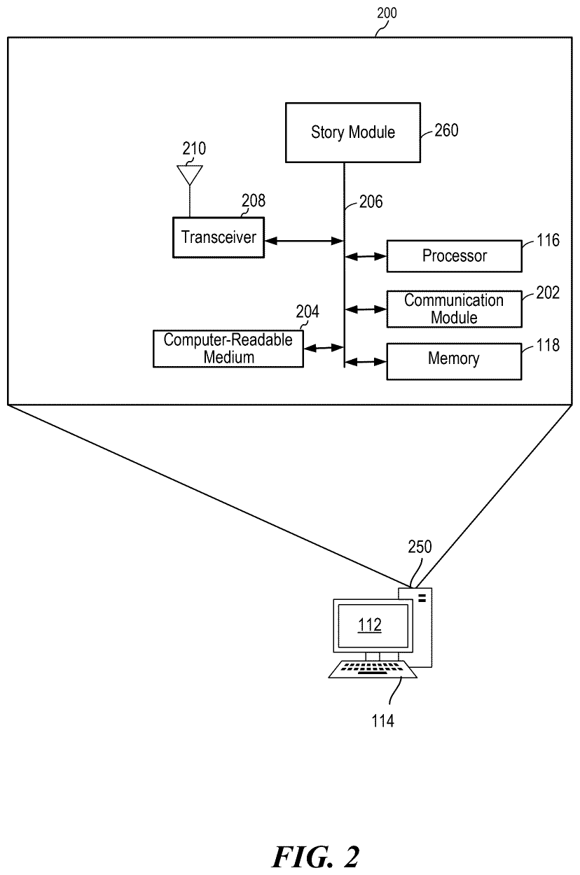

In some examples, a story module may maintain the server 120. The server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 116 may execute instructions for maintaining the story module, training the story module, and/or executing the story module. In some examples, the processor 116 of the server 120 is configured to perform operations and implement one or more elements associated with one or more processes, such as the process 800 described with respect to FIG. 8. Additionally, or alternatively, the processor 116 of the server 120 may be configured to perform operations associated with the story module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 800 described with reference to FIG. 8.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

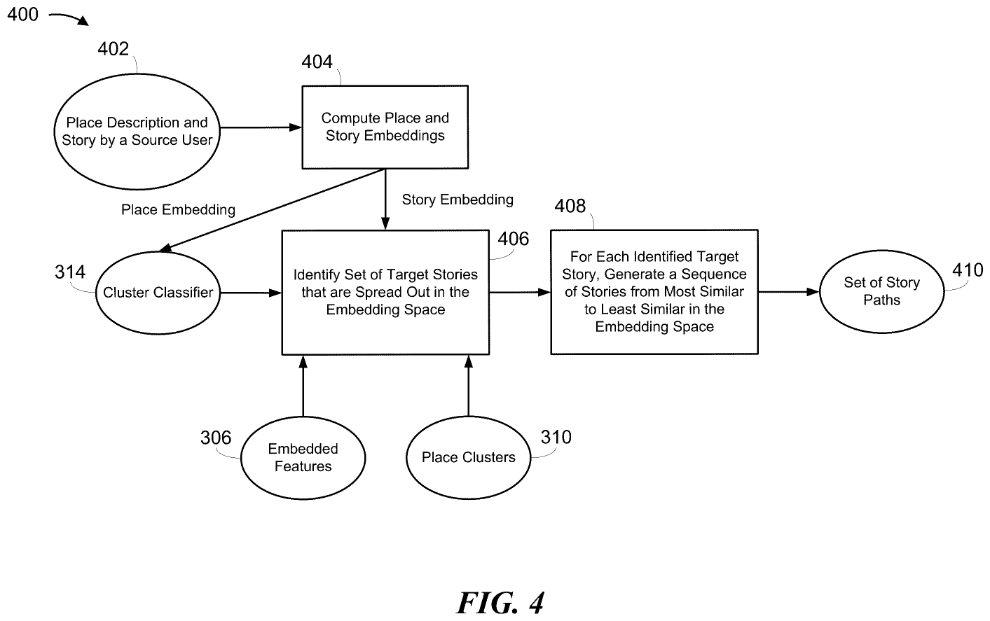

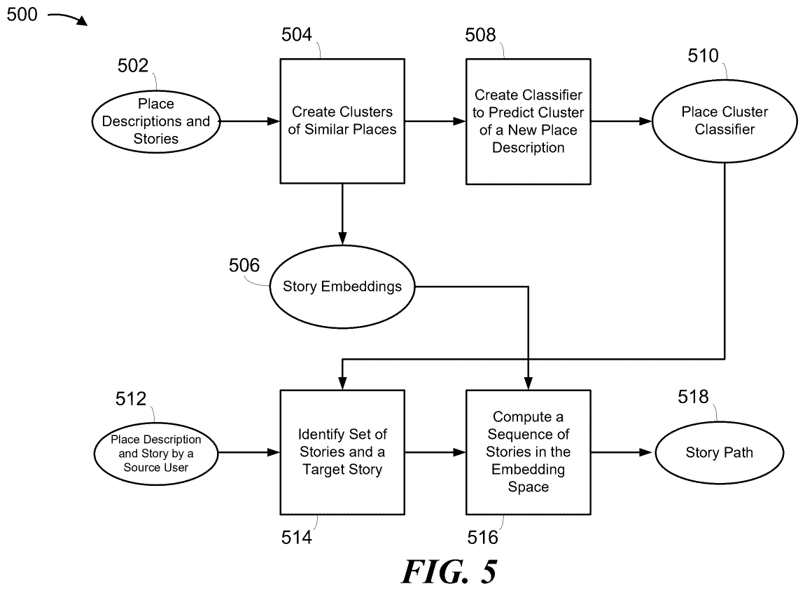

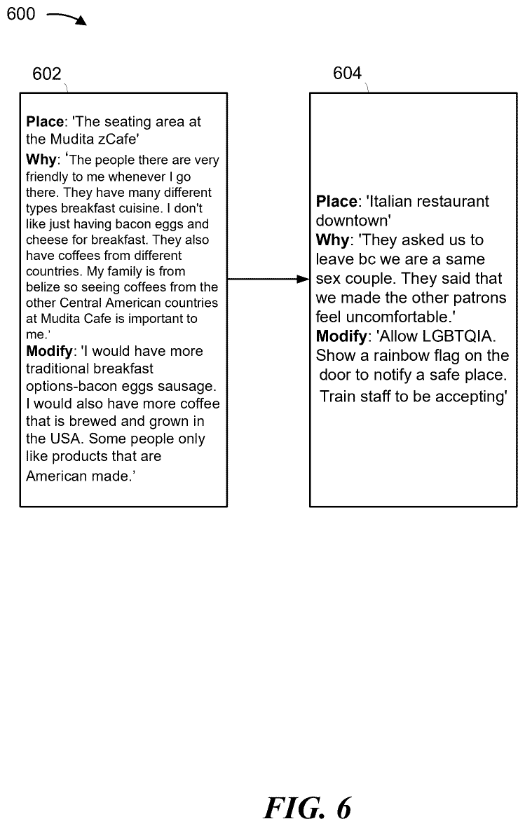

As shown in the example of FIG. 2, the system 200 may include a story module 260 that may be trained to perform one or more tasks associated with generating story paths. For example, the story module 260 may be trained to perform the tasks described with reference to the one or more pipelines described with reference to FIG. 4, FIG. 5, and FIG. 6. The story module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the story module 260 to implement one or more elements associated with one or more processes, such as the process 800 described with respect to FIG. 8. The computer-readable medium 204 may also be used for storing data that is manipulated by the processor 116 when executing the software. For example, working in conjunction with one or more of the other modules the modules 116, 118, 202, 204, and 208, the story module 260 may receive, from a source user, a source story. The story module 260 may additionally match the source story to a topic in a set of topics. The story module 260 may also identify a set of stories associated with the topic, each story of the set of stories being provided by one or more other users. The story module 260 may further present, to the source user based on identifying the set of stories, a subset of stories of the set of stories in a sequence from most similar, in an embedding space, to the source story to least similar, in the embedding space, to the source story. A final story in the sequence being a target story. The final story is one story of the subset of stories.

As indicated above, FIGS. 1 and 2 are provided as examples. Other examples may differ from what is described with regard to FIGS. 1 and 2.

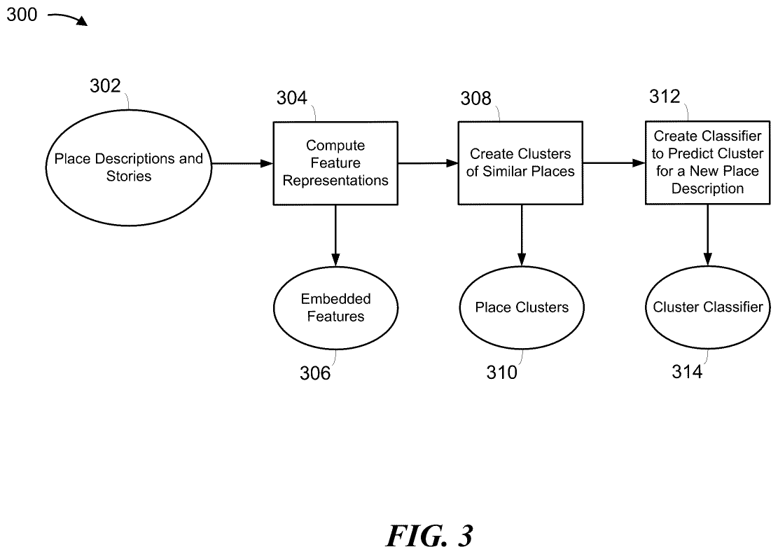

FIG. 3 is a flow diagram illustrating a story path pre-processing pipeline, in accordance with aspects of the present disclosure. The pipeline 300 may be implemented by a device, such as a device 250 or a story module 260 as described with reference to FIG. 2, or a system 100 as described with reference to FIG. 1. As illustrated in FIG. 3, the pipeline 300 may pre-process a dataset of place descriptions and stories to create embedded features 306, place clusters 310, and a cluster classifier 314. The pipeline 300 may begin with a set of place descriptions and stories 302. The set of place descriptions and stories 302 may include one or more place descriptions and one or more stories associated with each place description. One or more users may produce the place descriptions and associated stories 302.

In some examples, a same user may produce a place description and a story associated with the described place. For example, the set of place descriptions and stories may include a first place description produced by a first user, as well as a story associated with the described place, also produced by the first user. The place descriptions may describe a location, such as a church, restaurant, or hospital. The stories may include a narrative associated with the place description. In some examples, the narrative may include a user's sentiment regarding the associated place. For example, a user may produce “Bob's Restaurant” as a place description and “they have good food” as a story. In other examples, the story may be a user's opinion for modifying the place associated with the place description.

The narrative may additionally, or alternatively, include information, such as a suggestion, associated with the place description. For example, a user may produce “Bob's Restaurant” as a place description and “they should offer vegan options” as a narrative. The story may additionally or alternatively comprise a demographic of the user, such as the user's race, national origin, or gender. In some examples, the place description may be suggested based on positioning information, such as GPS information, obtained by a user device, such as the device 250 described with reference to FIG. 2. The place descriptions and stories 302 may be posted on one or more social media platforms, websites, and/or proprietary applications for providing opinions, thoughts, and/or other types of feedback. For example, one of the stories 302 may be a video post including a narrative of a place. The narrative may be an audio and/or text narrative. Additionally, or alternatively, one of the stores 302 may only be a text post including a text narrative of a place. A story module may scrape the place descriptions and stories 302 from the one or more social media platforms, websites, and/or proprietary applications. Additionally, or alternatively, the story module may directly or indirectly receive the place descriptions and stories 302 from the one or more social media platforms, websites, and/or proprietary applications.

At block 304, the pipeline 300 may compute feature representations based on the place descriptions and stories 302. The feature representations may be a lower-dimensional representation of each of the stories. The lower-dimensional representation may be a transformed or reduced version of the original story that captures essential information while having fewer dimensions or components. The pipeline 300 may implement information reduction techniques, such as dimensionality reduction or feature extraction to preserve characteristics or patterns of the original story while reducing complexity. For each story, one or more feature representations may be generated, each feature representation representing an individual property or characteristic of the story. To generate the embedded features 306, the place descriptions and feature representations may be embedded in an embeddings space, the embedding space may include any amount of embeddings. For example, the embedded transformer features from known models, such as OpenAI™'s ada_002 may be used to generate feature representations for a number of stories. These feature representations may then be embedded, with the place description associated with the feature representation's story, as embeddings in an embedding space. Conceptually, the embedding space may be similar to a grid, where each embedding may be conceptualized as points on the grid.

At block 308, the pipeline 300 may include creating place clusters 310 of similar places. Embeddings representing places are clustered and the clusters recorded. In some examples, a known clustering function or classification function may be used to produce the clusters. For example, agglomerative clustering with Ward linkage may be used to generate clusters, where one cluster may be associated with restaurants, another cluster associated with religious institutions, and still another cluster associated with residential housing.

At block 312, a cluster classifier 314 is generated (e.g., trained) to predict the cluster of a new place description. The pipeline 300 may include training a neural network based on the place descriptions and stories 302, place clusters 310, and embedded features 306. In some examples, a classification model may be trained to classify new place descriptions. For example, the place descriptions may be given labels such as “restaurant” or “religious institution.” The labels may be associated with the clusters generated by the cluster classifier 314. The model may then be trained based on the labeled dataset of place descriptions. Once trained, the cluster classifier 314 may implement the model to predict the cluster of a new place description.

FIG. 4 is a flow diagram illustrating a story path processing pipeline, in accordance with aspects of the present disclosure. Various devices may implement the pipeline 400, such as the device 250 or story module 260 described with reference to FIG. 2, or a system 100 described with reference to FIG. 1. As illustrated in FIG. 4, the pipeline 400 may begin by receiving a place description and a story 402 from a source user. The source user may be a new user that has not provided input to the place description and stories 302. The source user may alternatively be a user that has provided input (e.g., one or more stories) to the place description and stories 302. At block 404, the pipeline 400 may include generating place and story embeddings based on the place description and story 402, or a narrative associated with the story 402. To generate the place and story embeddings, the pipeline 400 may implement an information reduction technique similar to the information reduction technique described with respect to the pipeline 300 described with reference to FIG. 3, where one or more lower-dimensional representations of the story may be generated and embedded with the source user's place description.

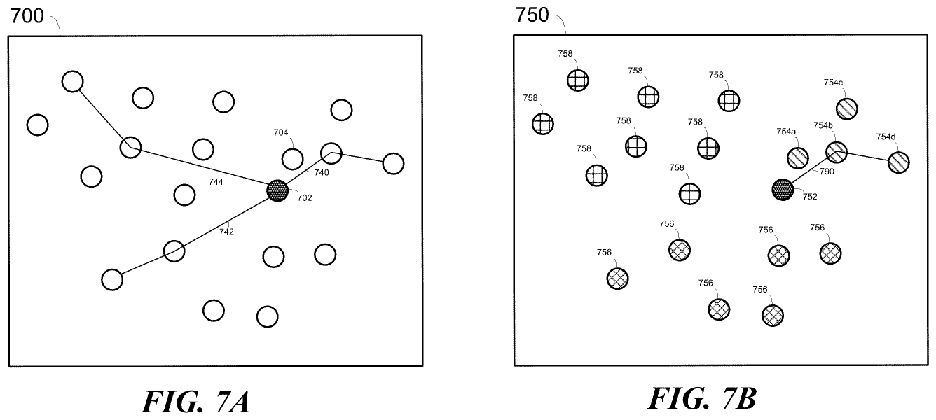

After the place and story embedding are generated at block 404, the place description may be used by the cluster classifier 314 to identify the cluster in the embedding space most closely associated with the place description. To classify the cluster and/or identify the embedding location of the place description, the cluster classifier 314 may implement one or more known classification techniques, such as logistic regression, Naïve Bayes classification, or support vector machine classification. An example place embedding location and cluster classification are described and illustrated in the example of FIG. 7B.

At block 406, the pipeline 400 may implement the embedded features 306, place clusters 310, and/or cluster classifier 314 to identify a set of target stories that are spread out in the embedding space. Each target story may be set as a final story in a sequence of stories (e.g., story path) that will be generated at block 408. The target story in a sequence of stories may be the story in a cluster that is least similar to the source story or the nth least similar to the source story in some aspect. For instance, the target story may be the story of a person with the most dissimilar demographics, or the story of a person with the third most dissimilar demographics in the source story's cluster. In some examples, the identification of target stories may be performed by identifying stories that are most distant in different directions in the story embedding space. The story embedding space may be clustered based on a place and/or one or more other factors.

For example, a group of place descriptions and associated stories may be embedded via the pipeline 300 described with respect to FIG. 3. The source user's place description and story may be similarly embedded in the embedding space. In this example, the source user may describe a gym as having a welcoming environment. The target stories identified may be stories describing a place, such as a school or restaurant, as having an unwelcoming environment. In some examples, target stories may be identified based on hard clustering of the stories. In such examples, the least similar story, in each cluster, from the source story may be designated as a target story.

By clustering stories, the pipeline 400 may identify a group of stories that may be used for a story path. In some examples, the cluster classifier 314 may perform hard clustering of stories. In such examples, the cluster classifier 314 may determine, based on a source user's place description, a proper place cluster of the place clusters 310. The story in the proper place cluster that is the least similar (e.g., most dissimilar) to the source story may then be designated as a target story. In this example, the source story may describe a high school as having a safe environment. Based on the source story, a story describing a college as having an unsafe environment may be identified as a target story.

In some other examples, the cluster classifier may identify, from a group of stories, a set of stories that are farthest, in the embedding space, from the source story. One or more stories of the set of stories may be identified as potential target stories based on a similarity between the story and the remaining stories in the cluster being greater than a threshold. For example, some clusters may include outlier stories that are unrelated to the topic of the cluster. By identifying potential target stories based on a similarity being greater than a threshold, the cluster classifier may prevent outlier stories from becoming a target story. Each remaining story from the group of stories may be associated with one story of the set of stories based on a respective distance between the remaining story and the one story of the set of stories.

At block 408, the pipeline 400 may generate a sequence of stories from most similar to least similar in the embedding space for each identified target story. To compute a sequence of stories, the pipeline 400 may generate an embedding based on the source user's story and calculate the similarity between the source user's story and each of the stories, in the cluster, associated with one or more other users. The stories may then be sorted from most similar to least similar. This sequence of stories, also referred to as a story path, may begin with the source user's story and end at a target story, as illustrated with respect to FIG. 7A and FIG. 7B. In some examples, the pipeline 400 may include generating any quantity of story paths as the set of story paths 410.

Stories in the set of story paths 410 may be presented to the source user. One or more techniques may be implemented to select the stories to be presented to the source user. In some examples, the source user may be shown stories from a story path in an order of stories most similar to the source user's story to least similar. A predetermined target distance, in the embedding space, between stories may be used to select stories for the story path. The target distance may represent a desired distance between stories in a story path. For example, the stories in the story path may be stories that satisfy a spacing condition, in the embedding space, between a source story and a target story. For example, the spacing condition may be satisfied if the stories are evenly spaced. Additionally, or alternatively, the spacing condition may be satisfied based on a distance between two stories. If the distance is within a range of the target distance, then the two stories may be added to the story path. The range is an example of a tolerance that is greater than and/or less than the target distance. In some examples, if no stories satisfy the spacing condition, a generative model may be used to generate one or more stories, in the story path, that satisfy the spacing condition. For instance, the pipeline 400 may generate, via a generative model, a generated story based on the stories in the story path, before adding the generated story to the story path.

At block 408, the pipeline 400 may implement one or more techniques to generate the sequence of stories. In some examples, users are asked to rate their empathy towards each story in a pair of stories. The empathy changes between each story are measured, and the empathy changes and similarity between story pairs can be used to identify a target distance between stories in the sequence of stories.

It is noted that although FIG. 3 and FIG. 4 illustrate processing pipelines implementing place descriptions, the place descriptions are an example of a topic and may additionally or alternatively comprise a different topic. In some implementations, place embeddings may instead be an embedding of some other topic. For example, a pre-processing pipeline similar to the pipeline 300 may implement a dataset of sports descriptions and stories. Using this dataset, the pre-processing pipeline may perform functions similar to those described with respect to FIG. 3. For example, the pre-processing pipeline may generate sports clusters and create a cluster classifier to predict the cluster of a new sports description. The pipeline 400 may then create a set of story paths based on a source user's sport description and story. The topic may comprise any subject or theme, such as current events, art, fitness, music, work, technology, food, or interest. If all the topic descriptions are substantially similar, then the set of story paths 410 may be generated without performing functions illustrated with respect to FIG. 3 and FIG. 4. For example, if all place descriptions in the place descriptions and stories 302 generally describe similar places, such as schools, then the set of story paths 410 may be generated without performing one or more functions illustrated with respect to FIG. 3 and FIG. 4. In this example, the pipeline 300 may compute feature representations at block 304 without creating clusters of similar places at block 308 or creating a cluster classifier at block 312. Additionally or alternatively, the pipeline 400 may not implement the place clusters 310 or cluster classifier 314.

FIG. 5 is a flow diagram illustrating a combined story path processing and pre-processing pipeline, in accordance with aspects of the present disclosure. The pipeline 500 may implement similar components of the pipeline 300 and pipeline 400 described with reference to FIGS. 3 and 4, respectively. Various devices may implement the pipeline 500, such as the device 250 or story module 260 described with reference to FIG. 2, or a system 100 described with reference to FIG. 1. The pipeline 500 may include place descriptions and stories 502. The place descriptions and stories 502 may include one or more place descriptions and one or more stories associated with each place description. One or more users may produce the place descriptions and associated stories. In some examples, the same user produces a place description and a story associated with the described place. For example, the set of place descriptions and stories may comprise a first place description produced by a first user, as well as a story associated with the described place, also produced by the first user. The stories may include a narrative associated with the place description, such as an experience or interaction the user had regarding the place. In some examples, the narrative may include a user's sentiment regarding the associated place, such as their perspective or opinion regarding the place.

At block 504, the pipeline 500 creates clusters of similar places in an embedding space. Embeddings representing places are clustered and the clusters recorded. Here, the set of stories of the place descriptions and stories 502 are clustered in the embedding space based on the topic, e.g. the place description. In some examples, the pipeline 500 may use a known clustering function or classification function to produce the clusters. The pipeline 500 may also include generating story embeddings 506 based on the place description and stories 502. To generate the story embeddings, the pipeline 500 may implement an information reduction technique similar to the information reduction technique described for the pipeline 300 described with reference to FIG. 3 and the pipeline 400 described with reference to FIG. 4.

At block 508, the pipeline 500 may create (e.g., train) a classifier to predict the cluster of a new place description. The pipeline 500 may train a neural network using the place descriptions and stories 502 and/or story embeddings 506. In some examples, a classification model may be trained to classify new place descriptions. Once trained, the place cluster classifier 510 may implement the classification model to predict the cluster of a new place description.

In some examples, a source user provides a place description and story 512. As discussed, the place description is an example of a topic. The source user may be a new user that has not provided input to the place description and stories 502, or a user that has already provided input to the place description and stories 502. Stories may include a narrative associated with the place description, such as an experience or interaction the source user had regarding the place. In some examples, the narrative may include the source user's sentiment regarding the associated place, such as the source user's perspective or opinion regarding the place.

At block 514, the pipeline 500 may identify a set of stories associated with the topic, e.g., the place description. The pipeline 500 may determine, for the source story, a first embedding, in the embedding space, associated with the story (e.g., the narrative or sentiment) and a second embedding associated with the topic (e.g., the place description). In some examples, the first embedding may be concatenated with one or more additional embeddings, such as an embedding associated with one or more attributes, including, but not limited to a demographic of the source user and/or other information, such as personality characteristics. The demographic may include a user's race, national origin, and/or gender, for example. The one or more attributes may be received as an input from the source user. Additionally, or alternatively, the one or more inputs may be determined based on meta-data and/or other data sources. In some examples, the meta-data may be a distinct input. The one or more attributes may be embedded during an embedding step, such as the embedding step 404 described with reference to FIG. 4.

The pipeline 500 may then identify a set of stories and/or a target story based on the first and/or second embeddings. To identify the set of stories and/or target stories, the pipeline 500 may implement the place cluster classifier 510. For example, the place cluster classifier 510 may identify a set of stories and a target story by determining a cluster associated with the place description and story 512 from a source user. One or more place descriptions and stories from the associated cluster may be used to identify the set of stories and target story.

At block 516, the pipeline 500 may select a sequence of stories in the embedding space. In some examples, the set of stories selected with respect to block 514, or a subset of the set of stories, may be ordered according to the similarity between stories. For example, the pipeline 500 may order a set of stories such that the order begins with a source story followed by one or more intermediate stories that are increasingly dissimilar to the source story. A target story may be the final story in the ordered set of stories. The story path 518 may be an ordered set of stories or a subset of the ordered set of stories. Any quantity of the stories in the story path 518 may be displayed to the source user in order of most similar in an embedding space to the source story to least similar in the embedding space to the source story.

Although various aspects of the present disclosure are directed to stories comprising text, stories may comprise other forms of user input, such as image, audio, or video data. In some examples, users may provide place descriptions and stories, the stories comprising a video file. A device may use one or more techniques to generate feature representations based on the video file. The device may transcribe the video file's audio into text and implement the text to create feature representations. Additionally or alternatively, a video recognition model may interpret a portion of the video file, and the device may generate feature representations based on the resulting interpretation.

FIG. 6 is a block diagram illustrating an example story path, in accordance with aspects of the present disclosure. The example story path 600 illustrated with respect to FIG. 6 comprises a source story 602 and a target story 604. To create the stories, users may describe a place where they feel welcome, excluded, safe, or unsafe. The user may then describe why the user feels welcome, excluded, safe, or unsafe in the place, and how the user would modify the place to make others feel welcome, excluded, safe, or unsafe. A device may use various techniques described with respect to FIGS. 3, 4, and 5 to receive the source story 602 and select the target story 604 based on the users' input. In the example of FIG. 6, the source story 602 is associated with a place description reciting “The seating area at the Mudita zCafe.” The source story 602 includes the source user's reasoning as to why the source user feels welcome in the place and suggested modifications regarding the place. Similarly, the target story 604 is associated with an “Italian restaurant downtown.” The target story 604 includes the user's reasoning as to why the user feels excluded in the place and suggested modifications regarding the place. Although the story path 600 only includes a source story 602 and target story 604, story paths may have any quantity of intermediate stories and associated place descriptions between a source story and a target story, as discussed with respect to FIGS. 3, 4, and 5.

FIGS. 7A and 7B are diagrams illustrating example embedding spaces and techniques to create a story path, in accordance with aspects of the present disclosure. As illustrated in FIG. 7A, an embedding space 700 comprises nineteen story embeddings 704 (a single story embedding 704 is labeled to simplify the illustration). One story embedding, the source embedding 702, is based on a story provided by a source user. Various techniques described with respect to FIGS. 3, 4, and 5 may be implemented to generate a first story path 740, second story path 742, and third story path 744. The final embedding in each of the first story path 740, second story path 742, and third story path 744 may be based on a target story.

As illustrated in FIG. 7B, a device may use clustering techniques to assign embeddings in an embedding space 750 to clusters. A first set of embeddings 756 may be associated with a first cluster, a second set of embeddings 758 may be associated with a second cluster, and a third set of embeddings 752, 754a, 754b, 754c, and 754d may be associated with a third cluster. The source embedding 752 is associated with a source story from a source user. After determining that the source embedding 752 is clustered with the third set of embeddings 754a, 754b, 754c, and 754d, the device may generate the story path 790 by identifying the story associated with a fourth embedding 754d as a target story and the story associated with a second embedding 754b as an intermediate story. Although the embedding spaces illustrated with respect to FIG. 7A and FIG. 7B comprise nineteen embeddings, embedding spaces having more or less than nineteen embeddings are contemplated. Additionally, a device may generate any quantity of story paths, each story path comprising any quantity of embeddings.

An example story path will now be provided. This example story path is a possible result of one or more techniques described with respect to the present disclosure. In the following example story path, the “pos user” is a source user that feels positive about a place. The pos user's place description and story are demonstrated. The pos user's story path may comprise stories by “neg users” that do not feel positive about the type of place mentioned by the pos user:
pos user: 4088573 [‘A church. A place I fellowship with other believers’ “Someone who doesn't know God well or his character. They may feel like they are not good enough”]
neg user: 4074834 [‘Christ Methodist church’ “I am an atheist so I don't necessarily feel welcome by any type of church. To be honest. This place makes me feel excluded because I knew someone from this church and when I told her I was an atheist she basically ghosted me and didn't want to continue a friendship since I didn't believe in God.” “You know I'm not really sure because a church is inherently a place for people who believe in god together. So, I guess more communication about accepting anyone despite their religion or a lack of religion.”]
neg user: 4068134 [‘A church and daycare’ “We initially sent my daughter here for daycare about a year ago. We pulled her out pretty soon afterwards because we did not agree with the way the children were taught in the overall belief system of the church.” “Be more tolerant of other people's views and have a more welcoming approach to teaching children. Overall, we want our daughter to be raised a well-rounded human being that accepts many other cultures. This church was very single-minded and did not have the acceptance we were looking for.”]
neg user: 4079888 [‘This is a local church in my town.’ “For a church that claims to have an open door, they are not inviting. There are constant signs outside making people not part of their faith feel inferior. They post upsetting signs and are anti LGBTQ and against people not of their religion.’ ‘I would have them hire a new PR person to manage their signage. There are plenty of churches around that use signs to show everyone is invited.’]
neg user: 4065661 [‘A Catholic Church in my neighborhood.’ “This place doesn't necessarily make me feel excluded but it doesn't make me feel included either. I'm not religious or a member of the Catholic faith so I feel like I wouldn't be welcome here.” “I would maybe add some signage or banners saying that members of all faiths and backgrounds are welcome. Or maybe some pamphlets outside that better explain the building and services and how to get more educated or involved.”]
neg user: 4065557 [‘I took a photo of our church.’ “Sometimes I feel excluded from our small church because others have been members for much, much longer. It's hard to develop strong bonds with other moms whom already have their core group and don't seem willing to expand beyond it. This makes me feel that my children are often excluded as well, which makes me sad.” “I wish I could organize a fun welcoming committee. The committee could oversee inclusion of new members, finding new members, and just making a more welcoming environment. I think doing this would truly give myself and others a platform to express concerns without feeling further excluded and not wanting to make waves.”]

Another technique to generate the sequence of stories includes selecting the sequence of stories from a set of stories based on a distance in a graph between each story, where the distance between each story of the set of stories is inversely associated with a similarity between each story of the set of stories. For instance, candidate stories may be represented in a graph, where each candidate story is represented as a node in the graph and each edge represents the distance between two stories (nodes). The edge between a pair of stories is assigned a distance that is inversely related to similarity, e.g., 1-similarity (story1, story2). The sum of the edge scores along a path between the positive user story and the target story represents the score for that particular sequence of stories that the path passes through. The shortest path between the positive user's story (e.g., pos user's story) and target story can then be identified as the story path. The positive user may be an example of a source user.

FIG. 8 is a flow diagram illustrating a method for generating a story path, in accordance with aspects of the present disclosure. The example process 800 is an example of generating a story path. At block 802, the process 800 receives, from a source user, a source story. The story may include a narrative and a demographic of the user. At block 804, the process 800 matches the source story to a topic in a set of topics. The topic may be, for example, a description of a place. In some examples, the source story may be embedded in an embedding space. In such examples, the source story may be associated with a first embedding.

At block 806, the process 800 identifies a set of stories associated with the topic, each story of the set of stories being provided by one or more other users. For example, the process 800 cluster the set of stories in the embedding space. Each topic of the set of topics may be associated with a cluster in the embedding space. Furthermore, the source story may be matched to the topic based on a distance to the cluster associated with the topic. For example, the closest topic, in the embedding space, may be matched with the source story. That is, the set of stories may be identified based on n a set of second embedding associated with the topic. In some examples, k-nearest neighbors may be used to identify the set of second embeddings. In some examples, the source story and each one of the set of stories includes a respective narrative on the topic. In some examples, the first embedding may be concatenated with a third embedding associated with one or more attributes of the source user. Additionally, each one of the set of second embeddings may be concatenated with a respective fourth embedding associated with one or more attributes of a target user. The one or more attributes may include demographic information and/or other user information, such as personality characteristics. The one or more attributes may be based on a user profile and/or an explicit input. In some examples, the one or more attributes may be obtained from meta-data.

At block 808, the process 800 presents, to the source user based on identifying the set of stories, a subset of stories of the set of stories in a sequence from most similar, in an embedding space, to the source story to least similar, in the embedding space, to the source story. A final story in the sequence being a target story. This sequence of stories may be a story path. In some examples, a generative model may generate a new story based on the subset of stories. The new story may be added to the subset of stories. In some examples, the subset of stories may be selected from the set of stories based on a distance in a graph between each story of the set of stories. The distance between each story of the set of stories is inversely associated with a similarity between each story of the set of stories.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for generating a story path, comprising:
receiving, from a source user, a source story;
matching the source story to a topic in a set of topics;
identifying a set of stories associated with the topic, each story of the set of stories being provided by one or more other users; and
presenting, to the source user based on identifying the set of stories, a subset of stories of the set of stories in a sequence from most similar, in an embedding space, to the source story to least similar, in the embedding space, to the source story, a final story in the sequence being a target story.

2. The method of claim 1, further comprising:
clustering the set of stories in the embedding space; and
generating, for the source story, a first embedding in the embedding space,
wherein:
each topic of the set of topics is associated with a cluster in the embedding space; and
the source story is matched to the topic based on a distance to the cluster associated with the topic.

3. The method of claim 2, wherein the source story and each one of the set of stories includes a respective narrative on the topic.

4. The method of claim 3, wherein the set of stories is identified based on a set of second embedding associated with the topic.

5. The method of claim 4, further comprising:
concatenating the first embedding with a third embedding associated with one or more attributes of the source user; and
concatenating each one of the set of second embeddings with a respective fourth embedding associated with one or more attributes of a target user.

6. The method of claim 1, further comprising:
generating, via a generative model, a new story based on the subset of stories; and
adding the new story to the subset of stories.

7. The method of claim 1, further comprising selecting the subset of stories from the set of stories based on a distance in a graph between each story of the set of stories, wherein the distance between each story of the set of stories is inversely associated with a similarity between each story of the set of stories.

8. An apparatus for generating a story path, comprising:
one or more processors; and
one or more memories coupled with the one or more processors and storing processor-executable code that, when executed by the one or more processors, is configured to cause the apparatus to:
receive, from a source user, a source story;
match the source story to a topic in a set of topics;
identify a set of stories associated with the topic, each story of the set of stories being provided by one or more other users; and
present, to the source user based on identifying the set of stories, a subset of stories of the set of stories in a sequence from most similar, in an embedding space, to the source story to least similar, in the embedding space, to the source story, a final story in the sequence being a target story.

9. The apparatus of claim 8, wherein:
execution of the processor-executable code further causes the apparatus to:
cluster the set of stories in the embedding space, and
generate, for the source story, a first embedding in the embedding space;
each topic of the set of topics is associated with a cluster in the embedding space; and
the source story is matched to the topic based on a distance to the cluster associated with the topic cluster the set of stories in the embedding space.

10. The apparatus of claim 9, wherein the source story and each one of the set of stories includes a respective narrative on the topic.

11. The apparatus of claim 10, wherein the set of stories is identified based on a set of second embedding associated with the topic.

12. The apparatus of claim 11, wherein execution of the processor-executable code further causes the apparatus to:
concatenate the first embedding with a third embedding associated with one or more attributes of the source user; and
concatenate each one of the set of second embeddings with a respective fourth embedding associated with one or more attributes of a target user.

13. The apparatus of claim 8, wherein execution of the processor-executable code further causes the apparatus to:
generate, via a generative model, a new story based on the subset of stories; and
add the new story to the subset of stories.

14. The apparatus of claim 8, wherein execution of the processor-executable code further causes the apparatus to select the subset of stories from the set of stories based on a distance in a graph between each story of the set of stories, wherein the distance between each story of the set of stories is inversely associated with a similarity between each story of the set of stories.

15. A non-transitory computer-readable medium having program code recorded thereon for generating a story path, the program code executed by a processor and comprising:
program code to receive, from a source user, a source story;
program code to match the source story to a topic in a set of topics;
program code to identify a set of stories associated with the topic, each story of the set of stories being provided by one or more other users; and
program code to present, to the source user based on identifying the set of stories, a subset of stories of the set of stories in a sequence from most similar, in an embedding space, to the source story to least similar, in the embedding space, to the source story, a final story in the sequence being a target story.

16. The non-transitory computer-readable medium of claim 15, wherein:
the program code further includes:
program code to cluster the set of stories in the embedding space, and
program code to generate, for the source story, a first embedding in the embedding space;
each topic of the set of topics is associated with a cluster in the embedding space; and
the source story is matched to the topic based on a distance to the cluster associated with the topic cluster the set of stories in the embedding space.

17. The non-transitory computer-readable medium of claim 16, wherein the source story and each one of the set of stories includes a respective narrative on the topic.

18. The non-transitory computer-readable medium of claim 17, wherein the set of stories is identified based on a set of second embedding associated with the topic.

19. The non-transitory computer-readable medium of claim 18, wherein the program code further comprises:
program code to concatenate the first embedding with a third embedding associated with one or more attributes of the source user; and
program code to concatenate each one of the set of second embeddings with a respective fourth embedding associated with one or more attributes of a target user.

20. The non-transitory computer-readable medium of claim 15, wherein the program code further comprises:
program code to select the subset of stories from the set of stories based on a distance in a graph between each story of the set of stories, wherein the distance between each story of the set of stories is inversely associated with a similarity between each story of the set of stories;
program code to generate, via a generative model, a new story based on the subset of stories; and
program code to add the new story to the subset of stories.
